(19) United States
(12) Patent Application Publication
(10) Pub. No.: US 2022/0148026 A1
(43) Pub. Date: May 12, 2022

(54) SYSTEMS AND METHODS TO TRACK GUEST USER REWARD POINTS

(71) Applicant: SMILE INC., Kitchener (CA)

(72) Inventors: William Curtis, Kitchener (CA); Eryn Alexa Dickison, Waterloo (CA); Jose Bento, Milton (CA); Dustin Duffy, Waterloo (CA); Clayton Passmore, Kitchener (CA); Matthew Hennessy, Kitchener (CA); Buraa Al Burghli, Kitchener (CA); Sivakumar Kailasam, Kitchener (CA); Edgar Alexander Willemsma, Kitchener (CA); Timothy Schmitke, Kitchener (CA); Ely Joaquin Alvarado Meza, Kitchener (CA); Nathaniel Lutz, London (CA)

(21) Appl. No.: 17/454,344

(22) Filed: Nov. 10, 2021

Related U.S. Application Data
(60) Provisional application No. 63/111,988, filed on Nov. 10, 2020.
(60) Provisional application No. 63/271,457, filed on Oct. 25, 2021.

(51) Int. Cl. G06Q 30/02; G06F 21/42

(52) U.S. Cl. CPC G06Q 30/0222; G06Q 30/0226; G06F 2221/2137; G06F 2221/2117; G06F 21/42

(57) ABSTRACT

An example e-commerce system includes an e-commerce platform to: receive a purchase order from a guest user, the purchase order including a guest user identifier representing a means of communication for the guest user; match the guest user identifier to a customer identifier; send a confirmation of the purchase order to the guest user via the means of communication for the guest user; and a loyalty rewards system to communicate with the e-commerce platform, the loyalty rewards system to: associate the customer identifier with a guest user account of the loyalty rewards system; and track reward points from the purchase order in association with the guest user account.

### TECHNICAL FIELD

The described systems and methods pertain to e-commerce transaction systems, and more particularly, to tracking activities and transactions of guest users.

### BACKGROUND OF THE INVENTION

Some existing e-commerce programs, commonly referred to as e-commerce platforms, allow users to shop at their merchant websites without providing much information or logging in until such users are ready to purchase a good or service. Thus, users can peruse websites, adding things to an online shopping cart typically until they are ready to “check-out,” thereby consummating a transaction. At that point, they are typically required to give personal information, along with financial information, to identify themselves to the e-commerce site in order to complete the purchase. Many users desire to complete their transactions without having to create or register an account with each site as there are too many sites and accounts to track. Such users without an account are referred to as guest users or guests. However, many merchants desire to have their guests create accounts in order to award them loyalty reward points for better customer retention rates and ultimately to increase their sales.

### BRIEF DESCRIPTION OF DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram depicting an Ecommerce System according to an example embodiment of the invention.

FIG. 2 is a flow chart depicting a method of implementing a loyalty reward program in accordance with an example embodiment.

FIG. 3 is a flow chart depicting a method to authenticate a guest user at the Website of the Merchant Store to manage their reward points in accordance with an example embodiment of FIG. 2.

FIG. 4 is a Screenshot of the Link depicting a part of the email message of Confirmation in accordance with the embodiment of FIG. 3.

FIG. 5 is a screenshot of the Email Login according to FIG. 4.3

FIG. 6 is a screenshot of an Authentication Link depicting a part of the message of Email in accordance with the embodiment of FIG. 3.

FIG. 7 is a flow chart depicting a method of implementing a loyalty reward program by a Loyalty Rewards System.

### DETAILED DESCRIPTION

Embodiments described herein provide enhanced computer- and network-based methods and systems for transparently tracking the online purchases and activities of guest users without requiring the guests to register or to create accounts with merchants while allowing for the guests to create accounts, if desired, and become registered users. In completing an online purchase of any product or services online, some information about the guest is provided to the merchant in order to complete the purchase such as payment information, contact information, delivery addresses, and other identifiers. Further, it is a practice to request the guest's telephone number and/or email address in order to provide a text message (such as SMS—Short Message Service) or email where written confirmation of the purchase may be sent. Accordingly, guests or shoppers may be tracked when they provide the same or similar information to merchants for their subsequent transactions.

There are a number of methods to identify and/or track customers or users such as by telephone numbers and email addresses. Identifiers of a user comprise one or more of the following: name of a person or entity, telephone number, text messaging identifier, email address, payment information, physical address, delivery address, billing address, IP address, advertising ID, device ID, customer ID, social network ID, payment wallet, digital wallet, and such other contact information as may be used or developed.

E-commerce platforms, such as SHOPIFY, support merchants going online to sell their products and services. Some of the e-commerce platforms further provide tracking or matching of the registered users and guest users on merchant websites. For example, a customer identifier (customer ID), for example a number, is assigned to each new guest when a purchase is made at a merchant's website. The e-commerce platform would assign the same custom ID to the same guest, where detected as the same guest, for a subsequent transaction or purchase. For example, a transaction record (such as for a purchase) in the accounts of the merchant as provided by the e-commerce merchant may include customer ID, details of the purchase, date, and amount. Where the guest is matched to an existing guest, the previously assigned customer ID is used. The matching algorithms of the e-commerce platforms may include payment information, telephone number, and email address of the guest.

The customer ID from some e-commerce platforms may also be associated with other identifiers of the purchaser like the purchaser's name, telephone number and email address. For example, some customer IDs may only be associated with a name and telephone number. Other customer IDs may only have a name and email address. Some other customer IDs may only have just an email address. The number of possible combinations of associations with an example purchaser is very large and may further change over time. For example a purchaser may change their telephone number, physical address, or email address. A purchaser's identifiers may have more than one telephone number, email address, etc. A purchaser's identifiers may also be transferred to other purchasers for various reasons such as a telephone number being transferred to another purchaser.

The identifiers which may identify (or associate with) a guest user may be highly complex. It is thus advantageous to use a guest matching service, which may provide customer IDs, as provided by some e-commerce platforms along with some example identifiers like telephone numbers and email addresses which can further be used to authenticate the guest or guests.

In accordance with the presently described systems and methods, the matching or association of guests to their transactions may generally be accurate enough to allow a loyalty rewards program to grant reward points for the guests in the records of the merchant. For example, the merchant can grant and accumulate reward points for their guest users using the customer ID provided by their e-commerce platform. The merchant records would grant the reward points based on a guest's purchase(s). The granted reward points would then be added to the reward points associated with the customer ID in the merchant's records. In addition to purchases of products or services, reward points may also be earned for other activities such as referring another user to a merchant, providing a review on a social network for the merchant, and creating an account with the merchant.

Once a guest user has earned reward points with a merchant, the guest user may redeem their reward points by creating an account with the merchant to become a registered user and redeeming their reward points using the process for redeeming reward points of registered users. The guest user may be linked to their registered user account through the same identifiers such as the same email address.

However, some guests may wish to redeem their reward points without becoming registered users. Guests may redeem their reward points through a Uniform Resource Locator (URL), commonly known as a link. An example link may be http://www.server.com/main/2557njfogugweg. The guest user may use the link to initialize the process to redeem the reward points. The process may include authenticating the guest user at some point.

Once a guest user is identified by various means including the techniques noted in this document, technical means may also be used to continuously track when the guest user visits a merchant website using the same computing device. For example, cookies (as is commonly known) or information packets may be used where the guest user may be identified when visiting a merchant's website. Similarly, a user with a registered account may be automatically signed into the account when visiting a merchant's website using known methods.

In addition to purchases of products or services, reward points may also be earned for other activities such as referring another user to a merchant, providing a review on a social network for the merchant, and creating an account with the merchant.

The present invention relates to a loyalty rewards application that is made available through a merchant's ecommerce storefront that is hosted by an ecommerce platform. The application seamlessly interfaces with the API of the ecommerce platform, such as the SHOPIFY platform, to provide for ease of use by the merchant. This allows the merchant to process recurring orders without requiring redirection to an external/third-party account.

The present invention further relates to an ecommerce system comprising a loyalty rewards system where guest users earn reward points from their purchases of products or services from merchants, and where guest users access their reward points to manage redemption of their reward points based on their means of communication.

For example, the e-commerce system may include: an e-commerce platform to: receive a purchase order from a guest user, the purchase order including a guest user identifier representing a means of communication for the guest user; match the guest user identifier to a customer identifier; send a confirmation of the purchase order to the guest user via the means of communication for the guest user; and a loyalty rewards system to communicate with the e-commerce platform, the loyalty rewards system to: associate the customer identifier with a guest user account of the loyalty rewards system; and track reward points from the purchase order in association with the guest user account.

The present invention further relates to a method comprising purchasing products or services by a guest user through an ecommerce system having a loyalty rewards system; earning reward points through the loyalty rewards system by the guest user for their purchases; and accessing their reward points to manage redemption of their reward points based on the guest user's means of communication.

For example, the method may include: receiving a purchase order from a guest user, the purchase order including a guest user identifier representing a means of communication for the guest user; matching the guest user identifier to a customer identifier; sending a confirmation of the purchase order to the guest user via the means of communication for the guest user; and associating the customer identifier with a guest user account of a loyalty rewards system; and tracking reward points from the purchase order in association with the guest user account.

As used herein, the term “merchant” is intended to be broadly construed to mean any type of seller, dealer, retailer, distributor, or store owner or operator, including a non-profit organization. The term “product” is intended to be broadly construed to mean any type of goods and/or services. The term “application” is intended to be broadly construed to mean any type of software product, whether delivered by download, storage device, or otherwise, whether an integrally provided component of the ecommerce platform or separately provided for integration and use therewith, and/or whether stored remotely and accessed over a communications network or stored locally. The term “loyalty rewards system” or “loyalty rewards platform” is intended to be broadly construed to mean an application providing the essential functionality, but not necessarily all of the functionally, described and claimed herein. The term “ecommerce platform” is intended to be broadly construed to mean any type of software technology solution that (a) provides merchant-facing backends that enable merchants to customize and manage customer-facing storefronts on their websites for selling their products to their customers and (b) has an API or other interface for working with the recurrence application as described herein (as such, the terms “application” and “platform” are used interchangeably herein with respect to the ecommerce software, and any distinction between these terms is not considered important to a full understanding of the invention).

As used herein, the terms “customer” and “user” are intended to be interchangeably herein and are to be intended broadly construed to mean the customers of the merchants. As used herein, the term “reward points” are intended to be construed to mean points of a loyalty reward program, but are also intended to mean currency (such as $5.00 dollars) as some loyalty reward programs may issue currency amounts instead of points or in combination with points.

It will be appreciated that although example embodiments are shown and described in conjunction with the SHOPIFY platform, the loyalty rewards system application can be implemented for use with other ecommerce platforms.

It will be appreciated that although example embodiments are shown and described in conjunction with the SHOPIFY platform, the loyalty rewards system application can be implemented for use with other ecommerce platforms and may also be used with servers or computers of merchants directly where the ecommerce platform functions are handled by the servers or computers of merchants. The functions of the loyalty rewards system, the merchant computer, and the ecommerce platforms are implemented in software and, as such, this software may be executed on any number of different computers, servers, and platforms without leaving the scope of this invention.

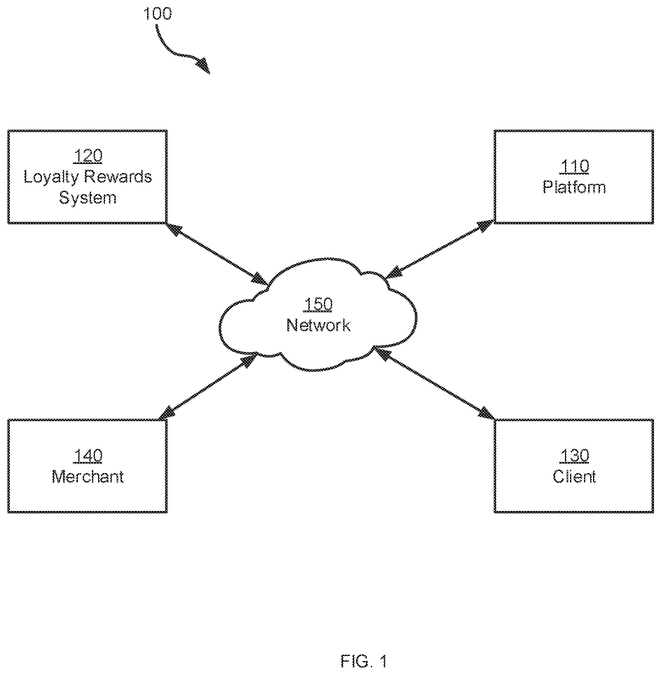

FIG. 1, there is shown a block diagram depicting an Ecommerce System 100 according to an example embodiment of the invention. The Ecommerce System 100 includes a Platform 110 that has an ecommerce platform application that communicates with a Loyalty Rewards System 120, a Client 130, and a Merchant 140. The Platform 110 can communicate with the Loyalty Rewards System 120, the Client 130, and the Merchant 140 via any suitable connection such as the Internet or another communications network 150. While certain embodiments are described in which parts of the Ecommerce System 100 are implemented in software, it will be appreciated that one or more acts or functions of the loyalty award system may be performed by hardware, software, or a combination thereof, as may be embodied in one or more computing systems. For example, the Loyalty Rewards System 120, the Platform 110, the Client 130, and the Merchant 140 can be embodied as stand alone application programs or as a companion program to a web browser having messaging and storage capabilities.

Further, although one Client 130 and one Merchant 140 are shown for ease of illustration, it should be appreciated that there are a number of merchants and/or clients who can be served by the Platform 110 in the manner described herein.

Similarly, although one Platform 110 is shown for ease of illustration, it should be appreciated that any number of them can be included in the Ecommerce System 100, for example in cloud-based and/or server-farm systems, or where the ecommerce platform and the application are located on separate but still connected/accessible servers (for example the recurrence application can call the ecommerce platform's API using the HTTP protocol).

Each Platform 110 is an ecommerce platform of a particular company. There are a number of ecommerce platform companies which could be represented by Platform 110 or Platforms 110. The description herein should be read to apply to one or more companies accordingly. For example, the Customer ID a user has with one company may not be the same as the Customer ID of the same user with another company unless the companies had agreed to standardize their Customer IDs.

The Loyalty Rewards System 120, the Platform 110, the Client 130, the Merchant 140 and/or other data processing resources as may be required, can communicate over the network 150. For example, the network 150 can include a telecommunications network, a local area network (LAN), a wide area network (WAN), an intranet, an Internet, or any combination thereof. In an exemplary embodiment, the communication between the Loyalty Rewards System 120, the Platform 110, the Client 130, and the Merchant 140 can be encrypted to protect and secure the data communication between the systems. It will be appreciated that the network connections disclosed are exemplary and other means of establishing a communications link between the Loyalty Rewards System 120, the Platform 110, the Client 130, and the Merchant 140 can be used.

The Platform 110 can include, for example, applications which may be used for or by the merchant. Such applications can provide for receiving, processing, and reconciling orders, billing, and inventory functions, and presenting such information to the Merchant 140. For example, such applications can include the ecommerce platform for hosting an e-commerce storefront (estorefront) for the Merchant 140 and making the estorefront interface accessible to the Client 130. And such applications can include an interface to the Merchant 140 to customize rule sets for offering products for sale to the users (e.g. users accessing estorefront from Clients 130), and accepting orders for such products.

The Platform 110 further provides functionality to assist the merchants in managing their estorefront. The merchants are able to track their users', whether registered or not (i.e. guests), activities relating to their estorefronts. For example, Platform 110 generates an event of each purchase order of a user from a merchant's estorefront. The event is associated with the merchant and the user and is accessible by both parties for their records. A record of the event can include customer ID (of the user), guest or registered (whether the user has created an account with the merchant), telephone number (of the user), email address (of the user), product purchased, date of purchase, and payment amount. This short list of information relating to a record is for illustration only. Such records may typically contain more or less information.

In some platforms, the telephone number or email address (or any other identifiers) of the user may be used as the customer ID by the platform to identify the user. The Platform 110 may assign a new customer ID to an event if it is not able to match the user to an existing user. If it is able to match the user to an existing user, the Platform 110 will provide the customer ID of the user to their purchase order. A registered user will have already created an account (store account) with the merchant and if the purchase is made under their account then the record of the event will have their assigned customer ID. Where a guest user (who does not have an account) makes a purchase, the record of the event will have the customer ID either as newly assigned where there is no match to an existing guest user, or an existing customer ID where a match is detected based on the profile of an existing guest user (for example, the same email address is used by the guest user).

The Merchant 140 is, for example, a computer from which a merchant can access and run their business through their e-storefront on the Platform 110. The Client 130 is, for example, a computer from which a user (who may be a shopper or customer) can access and interact with the e-storefront of various merchants to, for example, purchase their products.

The Loyalty Rewards System 120 implements a loyalty reward program for merchants through their e-storefronts. The Loyalty Rewards System 120 is configured to create, collect, manage, and modify information associated with user loyalty rewards accounts. Information associated with a loyalty rewards account can include, for example, user identification information, user contact information, user purchase information, historical user information, a loyalty award amount (the reward points), and other information necessary for implementing the Loyalty Rewards System 120.

The Loyalty Rewards System 120 is further extendable to the web pages of the e-storefront in the form of an embedded application within the web pages. The embedded application provides a user interface for interacting with users and displaying data relevant to a user's loyalty rewards account. The interactions with the users further include presenting nudges to the user while the user is shopping anywhere on a website including viewing the cart, home page, and product pages. Further, the user may also be presented with action items such as click to use points, select what to redeem for in a panel, apply rewards to items in a cart, apply code, and click to view rewards.

The records of events are processed by the Loyalty Rewards System 120 and reward points are awarded for each of the events which are then added to the loyalty rewards accounts of the users. The loyalty rewards accounts are identified by their respective customer IDs for both guest users and registered users. The accounts of guest users are referred to as guest accounts, and the accounts of registered users are referred to as registered accounts.

In some examples, the Loyalty Rewards System 120 may be implemented on a server or suite of servers separate from the Platform 110, while in other examples, the Loyalty Rewards System 120 may be integrated with and implemented by the Platform 110.

The Platform 110 can also include sending a text message using a messaging service to confirm the events, e.g. purchase order, to the user's messaging address. The message address may be a telephone number for text messages, an email address for text messages, and any other messaging service. Messages on the reward points earned by the users may similarly be sent to the users whether they are guest users or registered users.

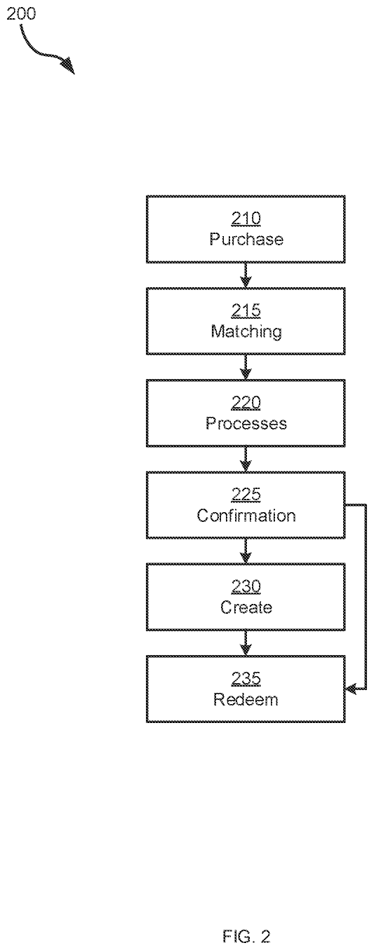

FIG. 2 is a flow chart depicting a Method 200 of implementing a part of the Loyalty Rewards System 120 in accordance with an example embodiment. The method 200 may be implemented in part or in whole by the Loyalty Rewards System 120, the Platform 110, or a combination of the two, or other suitable computing devices and/or systems. An example entry point into the Loyalty Rewards System 120 for a guest user starts with a Purchase 210 of a product(s) from a Website of a Merchant Store. From the Client 130, the user selects the product(s) to purchase and provides the information requested for purchase including providing an email address (given as an example messaging service). The Platform 110 thus receives a purchase order from the guest user operating the Client 130. The purchase order includes a guest user identifier representing a means of communication for the guest user. For example, the guest user identifier may be an email address, a phone number, or the like, representing communication via email service, via text message, via another messaging service, or the like.

The Purchase 210, once submitted for checkout (a commonly known process), is received by the Platform 110 for Matching 215 the guest user to determine if the guest user has previously purchased from the merchant. The Matching 215 can be, for example, on the basis of having the same email address. When the email address (or other guest user identifier) is matched to data in a field of an existing customer ID, the existing customer ID is used. When the guest user identifier does not correspond to any existing customer IDs, a new customer ID would be assigned to the guest user and it would be assumed that the user has not previously purchased from the merchant. The previously assigned customer ID would be used for the guest user if the user had previously purchased from the merchant.

In the event the guest user has previously purchased from the merchant and has also created an account with the merchant to become a registered user, but may not have remembered as such, the earned reward points from the Purchase 210 may continue to be added to the registered account of the “guest” user or registered user.

With the customer ID, the Platform 110 Processes 220 the purchase. The processing may include billing the guest user and sending a message to confirm the purchase (or event). A record of the event, this purchase, is updated for the merchant's account on the Platform 110. The Processes 220 further includes providing this purchase event to the Loyalty Rewards System 120 so that reward points or rewards can be awarded to the guest user's customer ID. The customer ID is effectively a loyalty rewards account or guest account in this example. Thus, the Loyalty Rewards System 120 may associate the customer ID with a guest user account of the Loyalty Rewards System 120 and may track the reward points from the Purchase 210 in association with the guest user account. In other examples, rather than matching the guest user identifier to a customer identifier at the Platform 110 prior to transmission to the Loyalty Rewards System 120, the Platform 110 may simply provide the guest user identifier (i.e., email address, phone number, etc.) to the Loyalty Rewards System 120, and the Loyalty Rewards System 120 may perform the Matching 215.

A Confirmation 225 of the purchase is also sent to the guest user so that they may have a confirmation of their purchase. This Confirmation 225 is, for example, sending a text message confirmation to the guest user's email address. Other known means of communicating this confirmation can also or instead be used. Further, the Confirmation 225 includes a URL link. The URL link may be an invitation to the guest users to Create 230 a store account with the merchant so that the guest user may become a registered user and be able to access their loyalty rewards account and to Redeem 235 their rewards accordingly. An example redemption of reward points is redeeming 100 reward points for a $10 discount code which the user can enter on their next purchase from the merchant for the discount. The URL link may also be to an authentication page including a login field to receive a guest user identifier to allow authenticate the guest user based on the guest user's means of communication (i.e., email address or the like), as will be described in further detail below. In still further examples, the link sent in the Confirmation 225 may be specifically generated for the guest user, and may include an embedded token or the like to allow the Platform 110 and/or the Loyalty Rewards System 120 to identify the customer ID of the guest user based on the link.

Alternatively, the URL link of Confirmation 225 sent via email, or an unsecured messaging service, can initially point to Redeem 235 as a redemption link for redemption within a limited redemption time period (for example one hour) and after expiry of the redemption time period, the URL link can then point to a registration page for the guest user to Create 230 an account to register the guest user.

Further alternatively, the URL link of Confirmation 225 sent via email, or an unsecured messaging service, can point to a web page indicating that a new URL link has been sent to the guest user's email address with Redeem 235 for redemption within a limited redemption time period (for example one hour). After the time period, this new URL link may be directed to the same web page indicating that another URL link has been sent to the guest user's email address with Redeem 235 for redemption within a limited period (for example one hour). This cycle of emails and URL links may be repeated as authentication for guest users to access their loyalty rewards accounts to view and/or redeem their reward points. Other authentication methods may also be used such Verification codes instead of URL links.

Where the Confirmation 225 has been sent to the guest user via a secured communication means such as via SMS to their telephone number, a URL link to Redeem 235 is included in the confirmation so that the guest user may accordingly redeem their reward points without becoming a registered user.

To Redeem 235, the Loyalty Rewards System 120 may match the guest user identifier to a stored guest user account having an associated record of rewards points. When the guest user selects an reward option to Redeem 235, the Loyalty Rewards System 120 decrements the rewards points associated with the guest user account by the specified amount for the reward option. For example, an example redemption of reward points is redeeming 100 reward points for a $10 discount code (i.e., the reward option) which the user can enter on their next purchase from the merchant for the discount.

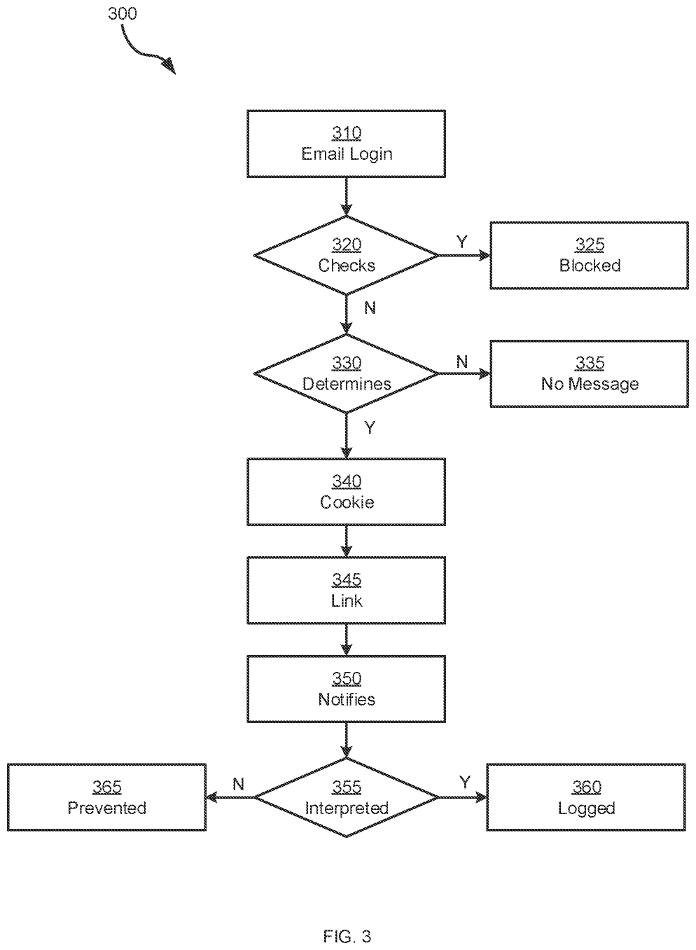

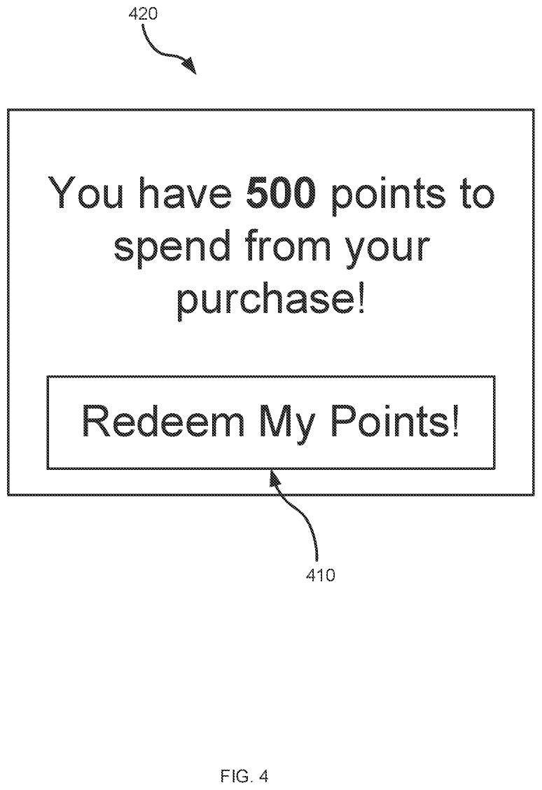

FIG. 3 is a flow chart depicting a method 300 by the Loyalty Rewards System 120 to authenticate a guest user at the Website of the Merchant Store to manage their reward points in accordance with an example embodiment of FIG. 2. The Confirmation 225, sent to users, contains URL links in which guest users may use to Redeem 235 their earned reward points. The Confirmation 225 is a message sent to the users where the message may be from a number of different types such as SMS messages, text messages, and email messages. In this example embodiment, an email message is sent as the Confirmation 225 (see FIG. 4 below).

FIG. 4 is a Screenshot 420 of the Link 410 depicting a part of the email message of Confirmation 225 in accordance with the embodiment of FIG. 3. In this implementation, the Link 410 (the URL link of Confirmation 225) is a graphic button with the words “Redeem My Points” where the user clicks this button to activate the URL link to direct the user's browser to a website. The Screenshot 420 may contain further information such as shown as “You have 500 points to spend from your purchase”.

Where the Purchase 210 was made by a registered user of the Merchant Store then the Link 410 may, for example, be www.merchantstore.com which leads to a regular landing page of the Website of the Merchant Store. The regular landing page would allow registered users to sign into their account as per usual.

Where the Purchase 210 was made by a guest user of the Merchant Store then the Link 410 may, for example, be www.merchantstore.com/123-authentication which leads to a landing page of the Website of the Merchant Store showing the embedded application of the Loyalty Rewards System 120 to authenticate the guest user as being in control of an email address associated with reward points. There are a number of known methods of email authentication. This method authenticates the email address of the user while also acting as access credentials for guest user accounts. Further, registered user email addresses and their accounts may also be authenticated using this method of directing registered users to www.merchantstore.com/123-authentication for authentication in that they control the associated email address.

While the above two Links 410 are shown as having different URLs; alternatively, the above two Links 410 may be the same URL where the Website of the Merchant Store always provides a part of the website for email authentication without using a password.

In this example embodiment, the Link 410 directs the user's web browser to a part of the Website of the Merchant Store where the user may enter their email address, Email Login 310, in a login field to access their account. In other examples, the login field may accept other types of guest user identifiers representing the means of communication (e.g., a phone number for text messaging, etc.) for the guest user. The Email Login 310 field is provided on the Website of the Merchant Store by the Loyalty Rewards Program 120 through its embedded app. The embedded application being an application embedded in the Website of the Merchant Store which provides a portal to interact and communicate with the Loyalty Reward System 120 from the Website of the Merchant Store.

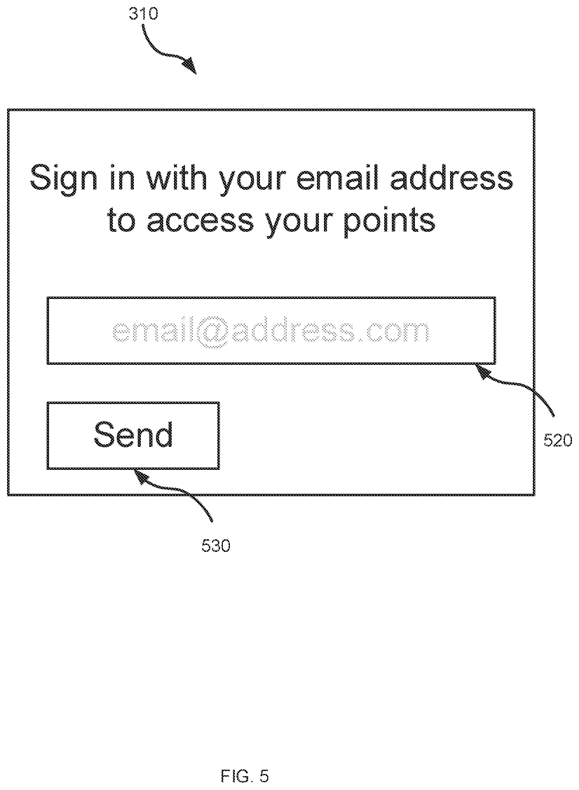

FIG. 5 is a screenshot of the Email Login 310 according to FIG. 4. The Email Login 310 having “Sign in with your email address to access your points”, a login Field 520 to enter the email address, and a Send 530 to submit the email address to the Loyalty Rewards System 120. The Loyalty Rewards System 120 then Checks 320 if the submitted email address is from a robot or automated system using known methods.

If the submission is determined to be YES, it is from a robot, then the submission is Blocked 325 it may be an attack against the Loyalty Rewards System 120. If the submission is determined to be NO, it is not from a robot, then the Loyalty Rewards System 120 Determines 330 whether the submitted email address is associated with a guest account. If NO then a NO message 335 “email not found” is sent back to the user.

If there is such a guest account associated with the submitted email address in the Loyalty Rewards System 120 then the Loyalty Rewards System 120 generates a first authentication code. This first authentication code is inserted as a Cookie 340 onto the user's device (one of the Client 130 computing devices) using known methods for placing a cookie onto the devices. A second authentication code is generated and incorporated into an Authentication Link 345 which link is sent in an Email 640 to the submitted email address by the Loyalty Rewards System 120. The submitted email address is officeaction@gmail.com in this example. This first and second authentication codes may each be a unique token, for example, a random number.

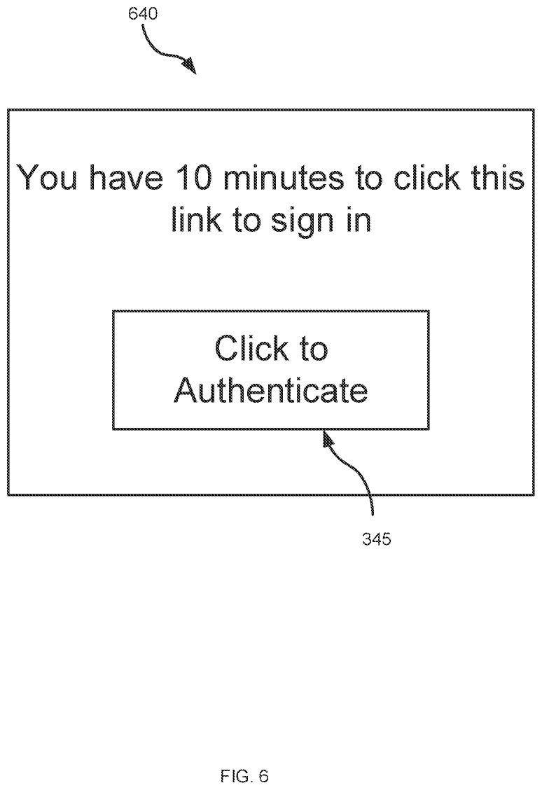

FIG. 6 is a screenshot of an Authentication Link 345 depicting a part of the message of Email 640 in accordance with the embodiment of FIG. 3. The Email 640 sent to officeaction@gmail.com has the Authentication Link 345 shown as a “Click to Authenticate” button and has text “You have 10 minute to click this link to sign in”.

The Loyalty Rewards System 120 Notifies 350 the user with the message “Check your email we have sent an email to officeaction@gmail.com” on its website. Upon receiving the email, the user opens the email and clicks to activate the Authentication Link 345. When the Authentication Link 345 is activated, the Authentication Link 345 is then Interpreted 355 by the embedded application of the Loyalty Rewards System 120 in the browser of the user's device to provide the first authentication code and the second authentication code to the Loyalty Rewards System 120 for authentication determination.

The Loyalty Rewards System 120 performs authentication determination with Determine (1) if the first authentication code is the same as the second authentication code, and with Determine (2) if the Authentication Link 345 has not expired. That is, the Loyalty Rewards System 120 verifies the second authentication code from the Authentication Link 345 against the first authentication code from the Cookie 340. The expiration is based on whether the Authentication Link 345 was clicked or activated by the user within a predetermined limited expiration time period (such as 10 minutes) of the email being sent to officeaction@gmail.com and when the second authentication code is received by the Loyalty Rewards System 120. The limited time period may be measured by other methods such as whether the Cookie 340 has expired.

If both Determine (1) and Determine (2) are determined by the Loyalty Rewards System 120 as YES then the guest user is authenticated as being associated with the guest account of officeaction@gmail.com and the user is Logged 360 into their guest account where a web page is provided by the Loyalty Rewards System 120 for the guest user to manage their reward points including redeeming rewards points into rewards. A reward may, for example, be a discount code (or coupon) for the user to apply to future purchases from the Merchant Store.

If any of Determine (1) and Determine (2) is determined by the Loyalty Rewards System 120 as NO, then the user is Prevented 365 from logging into the guest account associated with the email address officeaction@gmail.com and a message indicating such is displayed to the user.

While the Checks 320 and Determines 330 have been included in this embodiment, it is understood that the Checks 320 and Determines 330 are optional for the purpose of authenticating guest users.

Alternatively, for enhanced security, the first authentication code and the second authentication code may be encrypted using any number of known methods. The Determine (1) would therefore decrypt the first authentication code and the second authentication code accordingly.

Further alternatively, for enhanced security, the first authentication code and the second authentication code are different numbers, such as random computer generated numbers, which are stored in the Loyalty Rewards System 120. The Determine (1) then determines whether the stored numbers match the first authentication code and the second authentication code accordingly for a YES.

Further alternatively, for enhanced security, the first authentication code is a random computer generated number and the second authentication code indicates where a copy of the first authentication code is stored in the Loyalty Rewards System 120. The Determine (1) then determines whether the stored number matches the first authentication code for a YES.

Further alternatively, for enhanced security, where the email address entered to log into a guest account is not an email address in the Loyalty Rewards System 120 associated with a guest account (this guest user does not exist in the Loyalty Rewards System 120), the embedded app of the Loyalty Rewards System 120 a inserts a dummy cookie into the user's device in order not to expose whether the email address has an account in the Loyalty Rewards System 120 to hackers. A check your email message may optionally also be displayed on the user's device.

Further alternatively, for only some security, the Authentication Link 345 is not checked against the Cookie 340, nor is a cookie inserted onto the user's device. The Interpreted 355 only uses Determine (2) to see if the Authentication Link 345 has not expired.

Further alternatively, while the example embodiment of FIG. 3 shows the Link 410 having www.loyaltyrewardssystem.com/123-authentication which leads to a landing page of the Website of the Merchant Store, the Link 410 may instead lead to a web page of the Loyalty Rewards System 120 for the Email Login 310. The remaining steps of FIG. 3 may be changed to the loyalty rewards system accordingly.

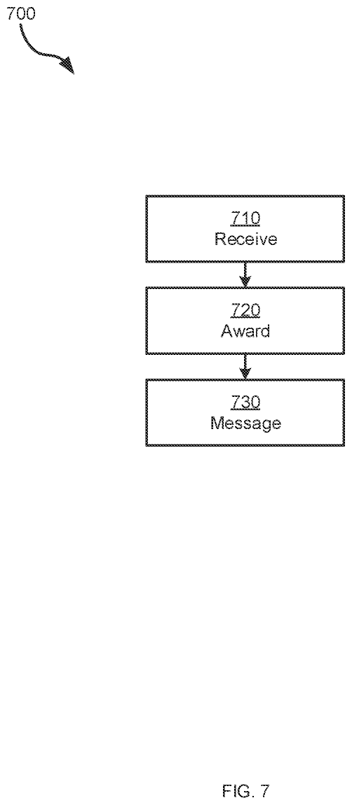

FIG. 7 is a flow chart depicting the Method 200 of FIG. 2 in the implementation by the Loyalty Rewards System 120 in accordance with an example embodiment. The example entry point into the Loyalty Rewards System 120 for a guest user starts with a Purchase 210 of a product(s) from a Website of a Merchant Store. The Loyalty Rewards System 120 Receives 710 from the Processes 220 the Purchase 210 information, as a purchase event, so that reward points or rewards can be Awarded 720 to the guest user's customer ID. The customer ID is effectively a loyalty rewards account or guest account in this example. Thus, the Loyalty Rewards System 120 may associate the customer ID with a guest user account of the Loyalty Rewards System 120 and may track the reward points from the Purchase 210 in association with the guest user account. In other examples, rather than matching the guest user identifier to a customer identifier at the Platform 110 prior to transmission to the Loyalty Rewards System 120, the Platform 110 may simply provide the guest user identifier (i.e., email address, phone number, etc.) to the Loyalty Rewards System 120, and the Loyalty Rewards System 120 may perform the Matching 215.

The Loyalty Rewards System 120 notifies the Platform 110 to include a Message 730 as part of the Confirmation 225 of the purchase is also sent to the guest user so that they may have a confirmation of their purchase. This Confirmation 225 is, for example, sending a text message confirmation to the guest user's email address. Other known means of communicating this confirmation can also or instead be used.

The Message 730 included in the Confirmation 225 is the URL link as an invitation to the guest users to Create 230 a store account with the merchant so that the guest user may become a registered user and be able to access their loyalty rewards account and to Redeem 235 their rewards accordingly. An example redemption of reward points is redeeming 100 reward points for a $10 discount code which the user can enter on their next purchase from the merchant for the discount.

Alternatively, the Message 730 with the URL link is sent by the Loyalty Reward System 120 via separate email (not the Confirmation 225 email) or another message service.

Where the Message 730 with the URL link is sent, whether by the Loyalty Reward System 120 or the Platform 110, to the guest user via a secured communication means such as via SMS to their telephone number; the URL link to Redeem 235 is set so that the guest user may accordingly redeem their reward points without further authentication of the guest user, or at least without further authentication of the guest user within a limited period of time.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

1. An e-commerce system comprising:
an e-commerce platform to:
receive a purchase order from a guest user, the purchase order including a guest user identifier representing a means of communication for the guest user;
match the guest user identifier to a customer identifier;
send a confirmation of the purchase order to the guest user via the means of communication for the guest user; and
a loyalty rewards system to communicate with the e-commerce platform, the loyalty rewards system to:
associate the customer identifier with a guest user account of the loyalty rewards system; and
track reward points from the purchase order in association with the guest user account.

2. The e-commerce system of claim 1, wherein the loyalty rewards system is further to:
receive, from a login field, the guest user identifier representing the means of communication for the guest user;
match the guest user to the guest user account based on the guest user identifier; and
allow the guest user to view and redeem the reward points associated with the guest user account.

3. The e-commerce system of claim 2, wherein the loyalty rewards system is further to:
authenticate the guest user using the guest user identifier prior to allowing the guest user to view and redeem the reward points.

4. The e-commerce system of claim 3 wherein, to authenticate the guest user, the loyalty rewards system is to:
generate a first authentication code as a cookie at a device of the guest user;
incorporate a second authentication code into an authentication link;
send the authentication link to the guest user via the means of communication; and
when the authentication link is activated, interpret the authentication link to verify the second authentication code from the authentication link against the first authentication code from the cookie.

5. The e-commerce system of claim 4, wherein the loyalty rewards system is further to determine whether the authentication link has been activated within a predetermined expiration time period to authenticate the guest user.

6. The e-commerce system of claim 3, wherein to authenticate the guest user, the loyalty rewards system is to determine whether the guest user identifier is received from an automated system.

7. The e-commerce system of claim 2, wherein the e-commerce platform is to include, in the confirmation of the purchase order sent to the guest user, a redemption link to access the login field to allow redemption of the reward points.

8. The e-commerce system of claim 7, wherein the e-commerce platform is to track a redemption time period for the redemption link; and wherein after expiry of the redemption time period, the redemption link is to access a registration page to register the guest user.

9. The e-commerce system of claim 1, wherein to match the guest user identifier to the customer identifier, the e-commerce platform is to:
when the guest user identifier corresponds to a field of an existing customer identifier, assign the existing customer identifier as the customer identifier; and
when the guest user identifier does not correspond to any field of any existing customer identifier, create a new customer identifier and assigning the new customer identifier as the customer identifier.

10. The e-commerce system of claim 1, wherein the means of communication comprises any of: text messaging, messaging services, and email service.

11. A method comprising:
receiving a purchase order from a guest user, the purchase order including a guest user identifier representing a means of communication for the guest user;
matching the guest user identifier to a customer identifier;
sending a confirmation of the purchase order to the guest user via the means of communication for the guest user; and
associating the customer identifier with a guest user account of a loyalty rewards system; and
tracking reward points from the purchase order in association with the guest user account.

12. The method of claim 11, further comprising:
receiving, from a login field, the guest user identifier representing the means of communication for the guest user;
matching the guest user to the guest user account based on the guest user identifier; and
allowing the guest user to view and redeem the reward points associated with the guest user account.

13. The method of claim 12, further comprising:
authenticating the guest user using the guest user identifier prior to allowing the guest user to view and redeem the reward points.

14. The method of claim 13 wherein authenticating the guest user comprises:
generating a first authentication code as a cookie at a device of the guest user;
incorporating a second authentication code into an authentication link;
sending the authentication link to the guest user via the means of communication; and
when the authentication link is activated, interpreting the authentication link to verify the second authentication code from the authentication link against the first authentication code from the cookie.

15. The method of claim 14, further comprising determining whether the authentication link has been activated within a predetermined expiration time period to authenticate the guest user.

16. The method of claim 13, wherein authenticating the guest user comprises determining whether the guest user identifier is received from an automated system.

17. The method of claim 12, further comprising including, in the confirmation of the purchase order sent to the guest user, a redemption link to access the login field to allow redemption of the reward points.

18. The method of claim 17, further comprising tracking a redemption time period for the redemption link; and wherein after expiry of the redemption time period, the redemption link is to access a registration page to register the guest user.

19. The method of claim 11, wherein matching the guest user identifier to the customer identifier comprises:
when the guest user identifier corresponds to a field of an existing customer identifier, assigning the existing customer identifier as the customer identifier; and
when the guest user identifier does not correspond to any field of any existing customer identifier, creating a new customer identifier and assigning the new customer identifier as the customer identifier.

20. The method of claim 11, wherein the means of communication comprises any of: text messaging, messaging services, and email service.
